(19) United States
(12) Patent Application Publication
(10) Pub. No.: US 2003/0136269 A1
(43) Pub. Date: Jul. 24, 2003

(54) Pyramid type handle with stable support function

(76) Inventor: Pi-Yun Chen, Taipei (TW)

Correspondence Address: BUCKNAM AND ARCHER, 1077 Northern Blvd., Roslyn, NY, 11576, US

(21) Appl. No.: 10/348,097

(22) Filed: Jan. 21, 2003

(30) Foreign Application Priority Data
Jan. 21, 2002 (TW) 091200504

(51) Int. Cl. A23L 1/00

(52) U.S. Cl. 99/275

(57) ABSTRACT

A pyramid type handle having stably support function mainly comprises a utensil body, the longitudinal central axis of which is inclined at a certain angle, so that said utensil body has a angle of elevation side as well as a angle of depression side, wherein a handle, provided at the depression side of utensil, consists of a vertical section extending vertically from the upper tip point at the angle of depression side, and a horizontal section extending horizontaly from the lower tip point at the angle of depression side, and a pyramid shape being formed by the horizontal section complementarily with the angle of depression side of said utensil, and said horizontal section and the bottom of utensil body are in the common plane. Thus, an enlarged support surface can be formed by the horizontal section and the bottom of utensil body in the common plane, so as to provide a stable support for utensil body.

### BACKGROUND OF THE INVENTION

The conventional utensil, such as cup or bottle etc., usually has a utensil body with certain height, a handle on side surface, and a bottom either having equal diameter or smaller diameter according to modification on utensil based on ergonomics viewpoint. Therefore, the stability of a utensil is often inverted proportional to its height. In order to improve the stability of traditional utensil, a Taiwanese New Utility Model Publication No. 315672 discloses “a cup mounting seat preventing cups from toppling”, and mainly comprises a cup mounting seat mainbody 10, a plurality of perforations 15 provided on said mainbody 10, a slightly concaved recess 101 additionally provided at the central position, an opening 102 provided at the center of the recess, a perforation 103 provided at the edge of recess, opening 102 and perforation 103 used for laying-up of a flexible suction cup 25, a plurality of U-shaped strips 20 formed as elastic metal strips, the spacing between the opening sides of which is slightly large, a flexible suction cup 25, at the center of which has a projecting retainer 251, and a projecting post 252 on the suction cup.

In abovementioned publication, the measure to increase the stability of utensil instead derives a toppling prevention device with complicated structure. This device not only changes the original profiling of utensil but also makes the use of utensil become a complexity due to its complicated structure, let alone the cost of this device. Thus, the inventor contemplates that there are still something concerning stability of utensil to be improved in contrast to the fact that the design of a traditional utensil handle only focus on the convenience of handcarry without considering any improvement on stability. Therefore, the invention is rendered that a common support surface is formed by the combination of utensil and handle, so as to provide a stable supporting structure.

### FIELD OF THE INVENTION

This invention relates to a utensil handle, especially to a novel pyramid type handle having stably support function, which utilizes an enlarged support surface formed by a horizontal section and bottom of a utensil body in the common plane, so as to provide a stable support for utensil body.

### SUMMARY OF THE INVENTION

Therefore, it is the main object of this invention to provide a pyramid type handle having stably support function, mainly comprising: a utensil body, the longitudinal central axis of which is inclined at a certain angle so that said utensil body has a angle of elevation side as well as a angle of depression side, wherein a handle, provided at the depression side of utensil, consists of a vertical section extending vertically from the upper tip point at the angle of depression side, and a horizontal section extending horizontaly from the lower tip point at the angle of depression side, and a pyramid shape being formed by the horizontal section complementarily with the angle of depression side of said utensil, and said horizontal section and the bottom of utensil body are in the common plane. Thus, an enlarged support surface can be formed by the horizontal section and the bottom of utensil body in the common plane, so as to provide a stable support for utensil body.

### BRIEF DESCRIPTION OF DRAWINGS

Above and other objects, features and effectiveness can be further understood by the detailed description of some embodiments of present invention in reference to the accompanying drawings, in which:

FIG. 1 is a schematic view showing the disclosure in the Taiwanese New Utility Model Publication No. 315672;

FIG. 2 is a perspective view showing the first embodiment of pyramid type handle of present invention, while FIG. 2a is a side view of it;

FIG. 3 is a perspective view showing the second embodiment of pyramid type handle of present invention, while FIG. 3a is a side view of it;

FIG. 4 is a perspective view showing the third embodiment of pyramid type handle of present invention, while FIG. 4a is a side view of it;

FIG. 5 is a perspective view showing the fourth embodiment of pyramid type handle of present invention, while FIG. 5a is a side view of it;

FIG. 6 and FIG. 6a are perspective views showing another embodiment of pyramid type handle of present invention.

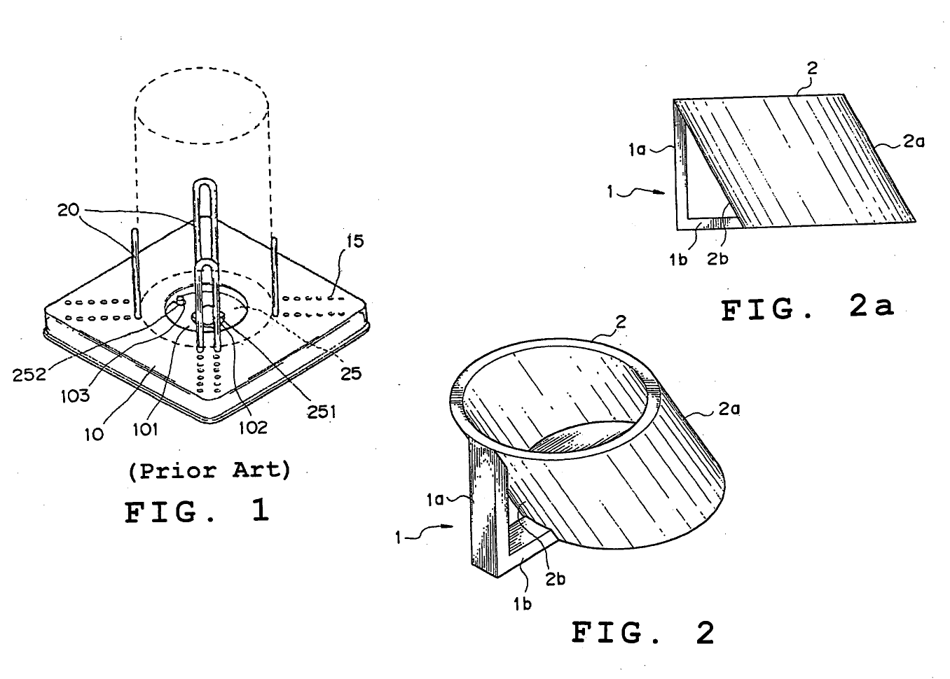

### DETAILED DESCRIPTION OF THE INVENTION (PREFERRED EMBODIMENTS)

Firstly, referring to FIG. 2 and FIG. 2a, in which a pyramid type handle 1 having stably support function is shown to be applied in an embodiment of a circular cup utensil and comprises a utensil body 2, the longitudinal central axis of which is inclined at a certain angle so that said utensil body 2 has a angle of elevation side 2a as well as a angle of depression side 2b, wherein a pyramid type handle 1 is provided at the depression side of utensil body 2. The pyramid type handle 1 consists of a vertical section 1a extending vertically from the upper tip point (i.e., the middle point at the outmost of periphery) at the angle of depression side 2b, and a horizontal section 1b extending horizontaly from the lower tip point (i.e., the middle point at the innermost of periphery) at the angle of depression side 2b, such that a pyramid shape can be formed by the horizontal section 1b complementarily with the angle of depression side 2b of said utensil body 2, and said horizontal section 1b and the bottom of utensil body 2 are in the common plane. Thus, an enlarged support surface can be formed in the common plane by the horizontal section 1b and the bottom of utensil body 2, so as to provide a stable support for utensil body 2.

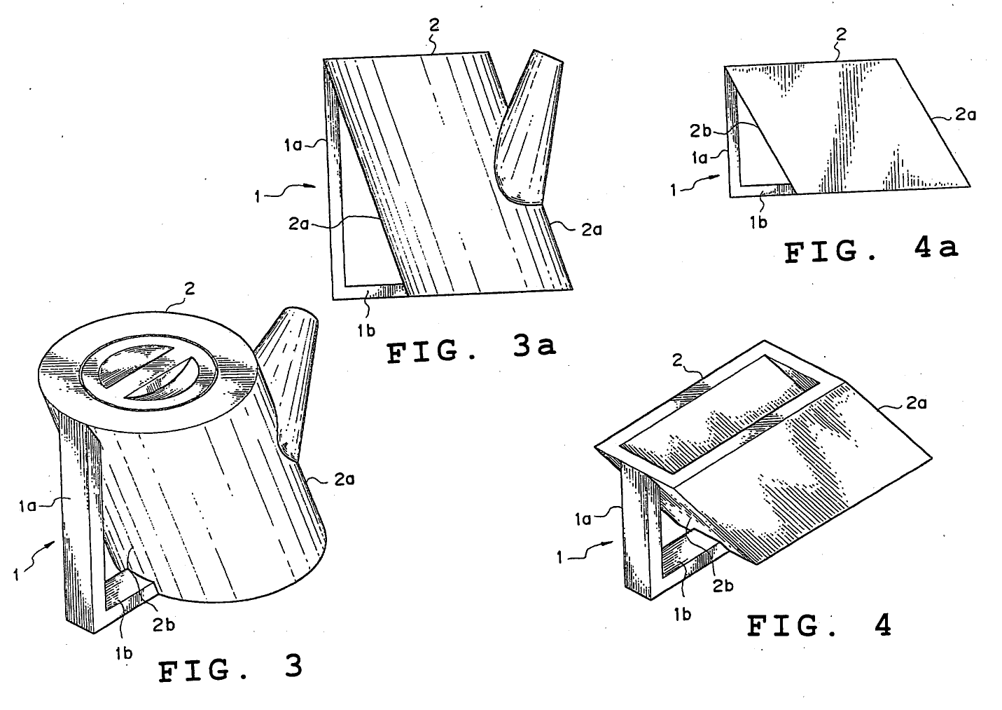

FIG. 3 and FIG. 3a are the examples of a pyramid type handle applied in the case of a circular bottle. The basic structure of this pyramid type handle 1 of the present embodiment is the same as that of the abovementioned embodiment, detailed description is therefore omitted.

FIG. 4 and FIG. 4a are illustrations of an embodiment in the application of a multi-sides polygon shape utensil. This embodiment has a multi-angle type utensil body 2, the longitudinal central axis of which is inclined at a certain angle so that said utensil body 2 has a angle of elevation side 2a as well as a angle of depression side 2b; wherein a pyramid type handle 1 is provided at the depression side of utensil body 2. The pyramid type handle 1 consists of a vertical section 1a extending vertically from the upper tip point (i.e., the middle point at the outmost of periphery) at the angle of depression side 2b, and a horizontal section 1b extending horizontaly from the lower tip point (i.e., the middle point at the innermost of periphery) at the angle of depression side 2b, in such a way that a pyramid shape can be formed by the horizontal section 1b complementarily with the angle of depression side 2b of said utensil body 2, and said horizontal section 1b and the bottom of utensil body 2 are in the common plane.

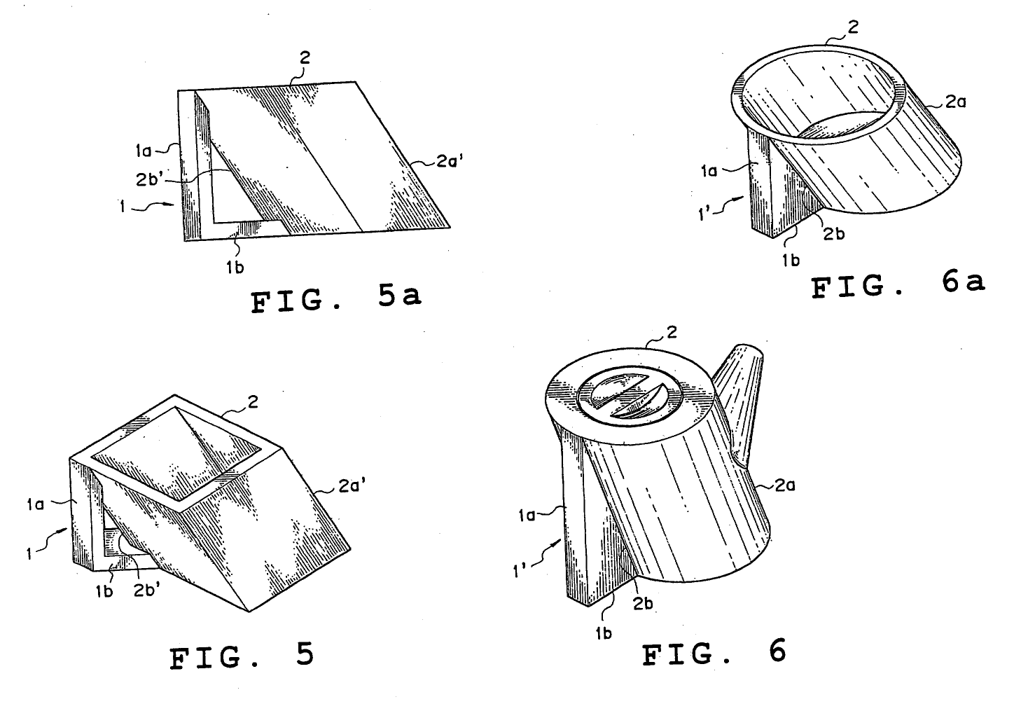

FIG. 5 and FIG. 5a are an illustration of another embodiment in the application of a multi-sides polygon shape utensil. The difference of this embodiment with the abovementioned is that angle of elevation side 2a′ as well as a angle of depression side 2b′ are formed at the intersection between two sides. Said pyramid type handle 1 is supported exactly at the upper and lower intersection at the angle of depression side 2b′, and formed into a complimentary pyramid shape with said angle of depression side 2b′.

In addition, it should be noted that the interior side of said pyramid type handle 1 can be hollow. Alternatively, the interior side of a pyramid type handle 1′ can also be solid in another embodiment as shown in FIG. 6 and FIG. 6a.

Based on the abovementioned, this invention provides a pyramid type handle in which the enlarged support surface is formed at the common plane by a horizontal section and bottom of a utensil, so as to provide stable support for utensil body. Therefore, it is substantially a novel invention having inventive steps and valuable availability for industrial applications.

While the aforementioned have been described in details with some preferred embodiments and illustrated by the accompanying drawings, it should not be considered as limitative of present invention. Various equivalent changes and modifications can be considered within the scope of this invention without departing from the spirit and scopes of present invention, which is clearly defined in the appended claims.

List of Reference Numberals

1; 1′ . . . pyramid type handle of present invention

1a . . . vertical section

1b . . . horizontal section

2 . . . utensil body

2a; 2a′ . . . angle of elevation side

2b; 2b′ . . . angle of depression side

What is claimed is:

1. A pyramid type handle having stably support function, mainly comprising: a utensil body whose longitudinal central axis is inclined at a certain angle, so that said utensil have a angle of elevation side as well as an angle of depression side, characterized in that a handle provided at the depression side of utensil consists of a vertical section extending vertically from the upper tip point at the angle of depression side, and a horizontal section extending horizontally from the lower tip point at the angle of depression side, a pyramid shape being formed by the horizontal section complementarily with the angle of depression side of said utensil, said horizontal section and the bottom of utensil body being in the common plane.

2. A pyramid type handle having stably support function as claimed in claim 1, wherein the interior side of said pyramid type handle is hollow.

3. A pyramid type handle having stably support function as claimed in claim 1, wherein the interior side of said pyramid type handle is solid.

4. A pyramid type handle having stably support function as claimed in claim 1, wherein said utensil body is a pyramid type utensil having polygon with multi-sides.

5. A pyramid type handle having stably support function as claimed in claim 4, wherein said handle is provided at the middle point of a side.

6. A pyramid type handle having stably support function as claimed in claim 4, wherein said handle is provided at the intersection of two sides.

7. A pyramid type handle having stably support function as claimed in claim 1, wherein said utensil body is a utensil with circular cross section, or cone type utensil.
